(19) United States
(12) Patent Application Publication
(10) Pub. No.: US 2012/0007522 A1
(43) Pub. Date: Jan. 12, 2012

(54) ILLUMINATION DEVICE

(75) Inventor: Chih-Ming Lai, Chu-Nan (TW)

(73) Assignee: FOXSEMICON INTEGRATED TECHNOLOGY, INC., Chu-Nan (TW)

(21) Appl. No.: 12/878,964

(22) Filed: Sep. 9, 2010

(30) Foreign Application Priority Data
Jul. 9, 2010 (TW) 99122590

(51) Int. Cl. H05B 37/02

(52) U.S. Cl. 315/297

(57) ABSTRACT

An illumination device configured to diffuse essential oils includes a plurality of light emitting diodes, a heat dissipation module, a thermal detector, and a controller. The heat dissipation module is thermally connected to the light emitting diodes. A receiving part is defined in the heat dissipation module. The receiving part is configured for receiving essential oils. The thermal detector is adjacent to the receiving part and configured for detecting a temperature of the essential oils. The controller is electrically connected to the light emitting diodes and the thermal detector. The essential oils are heated by the heat generated by the light emitting diodes through the heat dissipation module. The temperature of the essential oils is controlled by the controller according to a thermal signal from the thermal detector.

### BACKGROUND

1. Technical Field

The disclosure relates generally to illumination devices, and more particularly to an illumination device with a thermal detector.

2. Description of the Related Art

There are many kinds of diffusers for burning essential oils. One way utilizes a lightbulb to heat and diffuse the oils. However, this method can easily result in overheating the essential oils. Thus, what is called for is an illumination device with a thermal controller that can overcome the disadvantage described.

### BRIEF DESCRIPTION OF THE DRAWINGS

FIG. 1 is a cross-section of an illumination device in accordance with a first embodiment of the disclosure.

FIG. 2 is a cross-section of an illumination device in accordance with a second embodiment of the disclosure.

### DETAILED DESCRIPTION

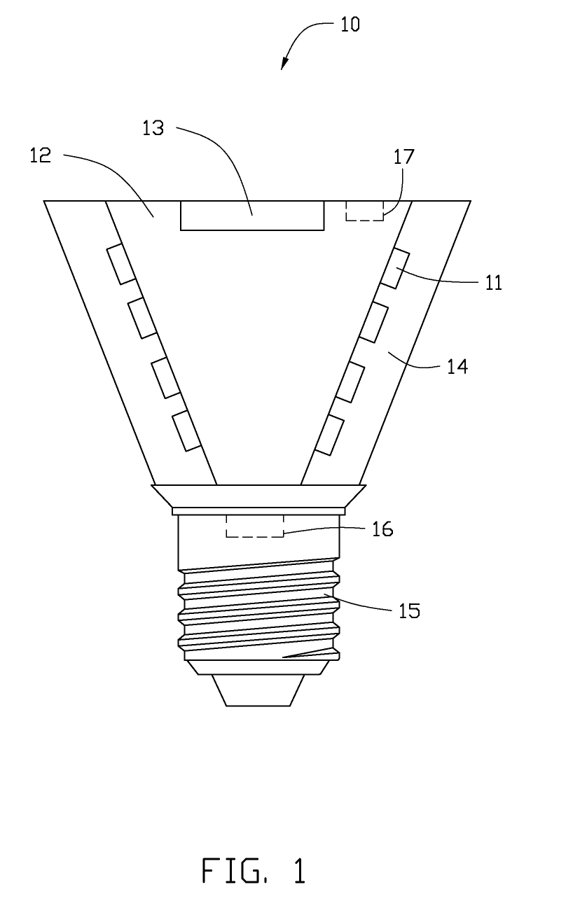

Referring to FIG. 1, an illumination device 10 configured to operate as a diffuser includes a plurality of light emitting diodes 11, a heat dissipation device 12, a cover 14, a connector 15, a controller 16, and a thermal detector 17. The light emitting diodes 11 are mounted on the heat dissipation device 12. A receiving part 13 is defined in the heat dissipation device 12 and configured for receiving essential oils. The cover 14 is made of transparent materials. The cover 14 is configured for being connected to the connector 15 and transmitting the light from the light emitting diodes 11. The controller 16 is received in the connector 15. The controller 16 is electrically connected to the light emitting diodes 11 and the thermal detector 17. The connector 15 is formed with a plurality of threads thereon. The connector 15 is configured for electrically connecting the illumination device 10 to a peripheral device, which according to this embodiment is a standard socket for an incandescent bulb, such as E17, E26, E27 and MR16.

The heat dissipation device 12 is essentially conical with truncated ends. The connector 15 is mounted on the bottom surface of the heat dissipation device 12.

The essential oils received in the receiving part 13 are heated by heat generated by the light emitting diodes 11 through the heat dissipation device 12. The thermal detector 17 is configured for detecting a temperature of the receiving part 13 and providing a thermal signal to the controller 16. The thermal detector 17 is located adjacent to the receiving part 13. The controller 16 is configured for controlling the light emitting diodes 11 according to the thermal signal. Thus, the temperature of the essential oils can be controlled to be between 40° C. and 70° C. The receiving part 13 is recessed from a top end of the heat dissipation device 12 and the light emitting diodes 11 are mounted on a circumferential periphery of the heat dissipation device 12. The top end of the heat dissipation device 12 is larger than a bottom end thereof. The controller 16 is located near the bottom end of the heat dissipation device 12.

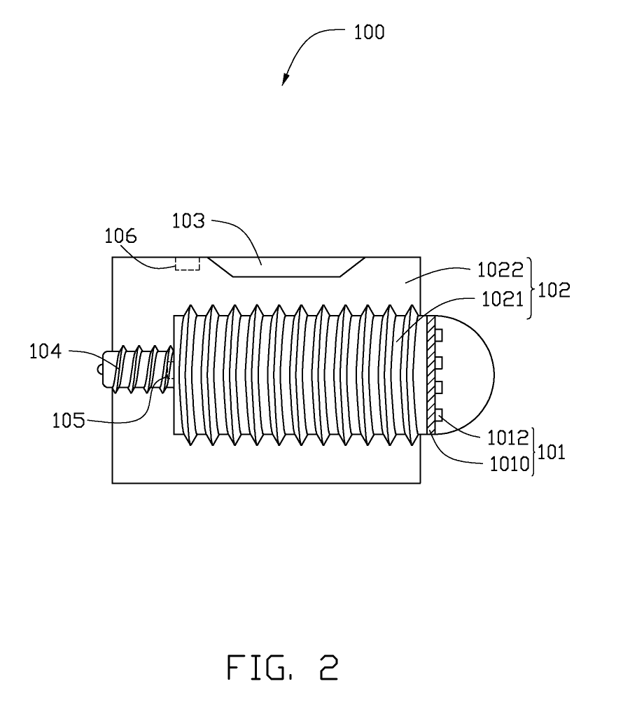

Referring to FIG. 2, an illumination device 100 configured for diffusing essential oils in accordance with a second embodiment of the disclosure includes a light source 101, a heat dissipation module 102, a receiving part 103, a connector 104, a controller 105, and a thermal detector 106. The light source 101 includes a printed circuit board 1010 and a plurality of light emitting diodes 1012 mounted on the printed circuit board 1010. The heat dissipation module 102 includes a first heat dissipation device 1021 and a second heat dissipation device 1022. The printed circuit board 1010 is attached to an end of the first heat dissipation device 1021, while the connector 104 extends outwardly from an opposite end of the first heat dissipation device 1021 along a direction away from the light source 101. The first heat dissipation device 1021 is columnar and formed with threads (not labeled) thereon. The first dissipation device 1021 is received in the second heat dissipation device 1022. The second heat dissipation device 1022 has a hole defining a plurality of threads (not labeled) therein which matingly engage with the threads of the first heat dissipation device 1021 to securely connect the first and the second heat dissipation devices 1021, 1022 together. The essential oils are received in the receiving part 103 and heated by the heat from the light emitting diodes 1012 through the first heat dissipation device 1021 and the second heat dissipation device 1022. The controller 105 is received in the connector 104 and electrically connected to the light emitting diodes 1012 and the thermal detector 106. The thermal detector 106 is located adjacent to the receiving part 103 and configured for detecting the temperature of the essential oils. The controller 105 is configured for controlling the light emitting diodes 1012 according to a signal from the thermal detector 106. The receiving part 103 is recessed from a top of the second heat dissipation device 1022 and the thermal detector 106 is received in the top of the second heat dissipation device 1022.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An illumination device configured for diffusing essential oils comprising:
a plurality of light emitting diodes;
a heat dissipation module, the heat dissipation module thermally connected to the light emitting diodes, a receiving part defined in the heat dissipation module, the receiving part configured for receiving the essential oils;
a thermal detector adjacent to the receiving part and configured for detecting a temperature of the essential oils; and
a controller electrically connected to the light emitting diodes and the thermal detector, the essential oils heated by the heat generated by the light emitting diodes through the heat dissipation module, the temperature of the essential oils controlled by the controller according to a thermal signal from the thermal detector.

2. The illumination device configured for diffusing essential oils as claimed in claim 1, wherein the heat dissipation module comprises a first heat dissipation device and a second heat dissipation device, the receiving part defined in the second heat dissipation device, the light emitting diodes mounted on and thermally connected to the first heat dissipation device.

3. The illumination device configured for diffusing essential oils as claimed in claim 2, wherein the first heat dissipation device is columnar.

4. The illumination device configured for diffusing essential oils as claimed in claim 2, wherein a plurality of threads are formed on the first heat dissipation device.

5. The illumination device configured for diffusing essential oils as claimed in claim 2, wherein the first heat dissipation device is received in the second heat dissipation device.

6. The illumination device configured for diffusing essential oils as claimed in claim 1, wherein the heat dissipation module has a configuration of a truncated cone, the light emitting diodes being mounted on a circumferential periphery of the heat dissipation module.

7. The illumination device configured for diffusing essential oils as claimed in claim 6, wherein the heat dissipation module has a large top end and a small bottom end, the receiving part is recessed from the top end and the thermal detector is received in the top end.

8. The illumination device configured for diffusing essential oils as claimed in claim 7 further comprising a cover covering the light emitting diodes.

9. The illumination device configured for diffusing essential oils as claimed in claim 7 further comprising a connector secured to the bottom end of the heat dissipation module and configured for connecting with a standard socket for an incandescent bulb.
